(19) United States
(12) Patent Application Publication
(10) Pub. No.: US 2007/0292801 A1
(43) Pub. Date: Dec. 20, 2007

(54) Thermal Transfer Receiving Sheet

(75) Inventors: Toshikazu Onishi, Tokyo (JP); Kyoko Uchida, Tokyo (JP); Kazuyuki Tachibana, Tokyo (JP); Naoki Kubo, Tokyo (JP)

Correspondence Address: KRATZ, QUINTOS & HANSON, LLP, 1420 K Street, N.W., Suite 400, WASHINGTON, DC, 20005, US

(73) Assignee: OJI PAPER CO. LTD., Tokyo (JP)

(21) Appl. No.: 11/663,006

(22) PCT Filed: Sep. 21, 2005
(86) PCT No.: PCT/JP05/17906

§ 371 Date: Mar. 15, 2007

(30) Foreign Application Priority Data
Sep. 21, 2004 (JP) 2004-274025

(51) Int. Cl. G03C 8/00

(52) U.S. Cl. 430/200

(57) ABSTRACT

A thermal transfer receiving sheet comprising a sheet-form substrate and a receiving layer having as a main component thereof a dye-dyeable resin formed on at least one side of said sheet-form substrate; wherein the receiving layer contains cellulose acetate butyrate and polyester resin having a number average molecular weight up to 10,000.

### TECHNICAL FIELD

The present invention relates to a thermal transfer receiving sheet (hereinafter, also be simply referred to as receiving sheet) having an image receiving layer (herein after, also be simply referred to as receiving layer) having as its main component a dye-dyeable thermoplastic resin. More particularly, the present invention relates to a receiving sheet having superior releasability from the dye layer of an ink sheet (hereinafter, also be referred to as ink ribbon) even during high-speed printing, superior adhesion with a transfer laminate layer (hereinafter, also be simply referred to as protective layer) of the ink ribbon, high recording density and superior light resistance.

### BACKGROUND ART

Dye thermal transfer methods consist of superposing an ink ribbon and a receiving sheet, transferring a subliminal dye of the ink ribbon dye layer to a receiving layer of the receiving sheet by heat supplied from a thermal head and so forth, and then separating the two to form an image. Examples of dye-dyeable resins proposed for use in the receiving layer include polyvinyl chloride resin, polyester resin, polyvinyl butyral resin, acrylic resin, cellulose resin and the like (see, for example, Japanese Unexamined Patent Publications (Kokai) Nos. 59-223425 (page 1), 57-137191 (page 1), 61-11293 (page 1) and 5-147366 (page 2)), while proposed examples of release agents include silicone release agents, fluorine release agents and fatty acid release agents (see, for example, Japanese Unexamined Patent Publications (Kokai) Nos. 60-34898 (page 1), 60-212394 (page 1) and 7-68948 (pages 2 and 3)).

In recent years, an “over-laminate” method has come to be frequently used to improve image storageability in terms of light resistance and oil resistance by providing a protective layer after sequentially transferring 3 or 4 colors of dyes to an ink ribbon (see, for example, Japanese Unexamined Patent Publication (Kokai) No. 59-76298 (page 1)). In this method, it is necessary to realize offsetting physical properties for the receiving layer consisting of releasability with respect to the dye layer surface of the ink ribbon and adhesion with respect to the protective layer surface of the ink ribbon. Although realization of releasability and adhesion was able to be accommodated by using a vinyl chloride resin or cellulose derivative for the dye-dyeable thermoplastic resin in the receiving layer, the use of vinyl chloride resins has been avoided in recent years due to the ease of generating dioxins during disposal by incineration, while cellulose derivatives have been unable to accommodate faster printing speeds in recent years due to their low recording density. Although the use of plasticizers and so forth has been proposed to increase the recording density of cellulose derivatives, printed images end up bleeding when stored at high temperature and high humidity, or the plasticizer ends up bleeding out when stored for long periods of time, thereby preventing images from being recorded normally.

On the other hand, although polyester resin has conventionally been used as a dye-dyeable resin having high recording density, it is difficult realize both releasability with the ink ribbon and adhesion with the thermal transfer protective layer when used as a receiving layer, while in the case of typical polyester resins having for their main components polyvalent carboxylic acids and aromatic glycol compounds, light resistance of printed images is poor, and the resulting receiving sheet is unable to stand up to practical use.

### DISCLOSURE OF THE INVENTION

An object of the present invention is to improve on the shortcomings of the prior art and provide a receiving sheet demonstrating satisfactory transfer of an ink ribbon protective layer to the surface of a receiving layer even during high-speed printing, demonstrating superior releasability from the ink ribbon, having high recording density, and demonstrating superior light resistance of resulting images.

The present invention includes each of the inventions indicated below.

(1) A thermal transfer receiving sheet comprising a sheet-form substrate and a receiving layer having as a main component thereof a dye-dyeable resin formed on at least one side of said sheet-form substrate; wherein the receiving layer contains cellulose acetate butyrate and polyester resin having a number average molecular weight of up to 10,000.

(2) The thermal transfer receiving sheet of (1), wherein the blending mass ratio of the cellulose acetate butyrate and the polyester resin is 5/95 to 95/5.

(3) The thermal transfer receiving sheet of (1) or (2), wherein the number average molecular weight of the cellulose acetate butyrate is at least 20,000.

(4) The thermal transfer receiving sheet of any of (1) to (3), wherein the polyester resin is a resin obtained by polycondensation of a polyvalent carboxylic acid component and a polyvalent alcohol component, the aliphatic dicarboxylic acid content of the polyvalent carboxylic acid component is greater than 50 mol %, and the alicyclic dicarboxylic acid content of the polyvalent carboxylic acid component is less than 50 mol %.

Moreover, the present invention also includes the invention indicated below.

(5) The thermal transfer receiving sheet of any of (1) to (4) above, wherein the sheet-form substrate has cellulose pulp as the main component thereof, and at least has an intermediate layer containing hollow particles between the sheet-form substrate and the receiving layer.

The thermal transfer receiving sheet of the present invention demonstrates satisfactory transferability against the ink ribbon protective layer, demonstrates superior releasability from the ink ribbon, has high printing density, demonstrates superior light resistance of resulting images, is free of the formation of cracks in the receiving layer, and is useful in sublimation thermal transfer and other thermal transfer types of full-color printers.

### BEST MODE FOR CARRYING OUT THE INVENTION

(Receiving Layer)

The present invention provides a thermal transfer receiving sheet comprising a dye-dyeable receiving layer formed on at least one side of a sheet-form substrate, wherein the dye-dyeable receiving layer contains cellulose acetate butyrate and a polyester resin having a number average molecular weight of up to 10,000 in the form of a dye-dyeable resin.

Although cellulose acetate butyrate (CAB) and saturated polyester resins have typically been used in the past as dye-dyeable resins, even if they are attempted to be used in combination while focusing on their respective properties, it was difficult to obtain a homogeneous coating solution due to their poor compatibility. Therefore, as a result of extensive studies, it became possible in the present invention to homogeneously blend cellulose acetate butyrate and form a receiving layer having superior practicality in terms of recording density by using a polyester resin having a number average molecular weight of up to 10,000 in the receiving layer of the present invention even though polyester resin used alone has a number average molecular weight in excess of 10,000. Moreover, the number average molecular weight of the polyester resin used in the receiving layer is more preferably 1,000 to 9,000 and most preferably 2,000 to 8,000. If the number average molecular weight of the polyester resin exceeds 10,000, the compatibility with the cellulose acetate butyrate becomes inferior, thereby preventing the obtaining of a homogeneous coating solution and preventing the obtaining of a satisfactory receiving layer surface.

In addition, there are no particular limitations on the ratio of the substituents, butryl, acetyl and hydroxyl groups in the cellulose butyrate acetate used in the receiving layer of the present invention. The number average molecular weight of the cellulose butyrate acetate is preferably at least 20,000, and more preferably at least 40,000. Although there are no particular limitations on the upper limit of the number average molecular weight of the cellulose butyrate acetate, the molecular weight of typical commercially available products is up to about 100,000.

If a cellulose butyrate acetate having a number average molecular weight of less than 20,000 is used in combination with a polyester resin having a number average molecular weight of up to 10,000, the receiving layer becomes brittle in low-temperature environments, resulting in the risk of the formation of cracks in the receiving layer when it is bent.

The blending mass ratio (A/B) of the cellulose butyrate acetate (A) to the polyester resin (B) is preferably 5/95 to 95/5, and more preferably 10/90 to 90/10. If the blending mass ratio (A/B) is less than 5/95, releasability from the ink ribbon becomes poor, while if the ratio exceeds 95/5, printing density decreases. Furthermore, although there are no particular limitations on the method used to measure the number average molecular weights of the polyester resin and cellulose butyrate acetate, they may be determined by using, for example, the gel permeation chromatograph (GPC) manufactured by Waters Corporation.

(Polyester Resin)

The polyester resin having a number average molecular weight in the present invention is synthesized by polycondensation of a polyvalent carboxylic acid component and a polyvalent alcohol component.

(Polyvalent Carboxylic Acid Component)

There are no particular limitations on the polyvalent carboxylic acid component used as the starting material of the polyester resin of the present invention, and various known polyvalent carboxylic acids can be used, examples of which include alicyclic dicarboxylic acids, aromatic dicarboxylic acids and aliphatic dicarboxylic acids. These may be used alone, or two or more types may be suitably used in combination.

Moreover, in order to improve the light resistance of recorded images, the amount of aliphatic dicarboxylic acid in the polyvalent carboxylic acid component of the polyester resin is preferably more than 50 mol % while the amount of alicyclic dicarboxylic acid is preferably less than 50 mol %, and if the amount of alicyclic dicarboxylic acid is 50 mol % or more, the use of the resulting polyester resin may cause a decrease in the light resistance of recorded images. More preferably, the amount of aliphatic dicarboxylic acid is 51 to 90 mol % and the amount of alicyclic dicarboxylic acid is 10 to 49 mol %, and most preferably the amount of aliphatic dicarboxylic acid is 52 to 60 mol % and the amount of alicyclic dicarboxylic acid 40 to 48 mol %. If the amount of aliphatic dicarboxylic acid exceeds 60 mol %, the glass transition temperature of the polyester resin decreases, which may cause a decrease in releasability from the ribbon.

Specific preferable examples of aliphatic dicarboxylic acids include malonic acid, succinic acid, maleic acid, succinic anhydride, maleic anhydride, glutaric acid, adipic acid, pimelic acid, methyl malonic acid, dimethyl malonic acid, suberic acid, azelaic acid, sebacic acid, isosebacic acid, brassylic acid, dodecane dicarboxylic acid, polyalkenyl succinic acid, dimer acids of polymerized fatty acids and hydrated dimer acids. Among these, succinic anhydride and maleic anhydride are most preferable. Aliphatic dicarboxylic acids typically have a linear hydrocarbon group, but may also be branched.

In addition, specific preferable examples of alicyclic dicarboxylic acids include 1,4-cyclohexane dicarboxylic acid, 2-methyl-1,4-cyclohexane dicarboxylic acid, 2-ethyl-1,4-cyclohexane dicarboxylic acid, 2-propyl-1,4-cyclohexane dicarboxylic acid, 2-butyl-1,4-cyclohexane dicarboxylic acid, 2-t-butyl-1,4-cyclohexane dicarboxylic acid, 2,3-dimethyl-1,4-cyclohexane dicarboxylic acid, 2,3-diethyl-1,4-cyclohexane dicarboxylic acid, 2,3-dipropyl-1,4-cyclohexane dicarboxylic acid, 2,3-dibutyl-1,4-cyclohexane dicarboxylic acid, 2-methyl-3-ethyl-1,4-cyclohexane dicarboxylic acid, 2-methyl-3-propyl-1,4-cyclohexane dicarboxylic acid, 2-methyl-3-butyl-1,4-cyclohexane dicarboxylic acid, 2-ethyl-3-propyl-1,4-cyclohexane dicarboxylic acid, 2-ethyl-3-butyl-1,4-cyclohexane dicarboxylic acid, 2-methyl-3-t-butyl-1,4-cyclohexane dicarboxylic acid, 2,6-decalin dicarboxylic acid, 3-methyl-2,6-decalin dicarboxylic acid, 3-ethyl-2,6-decalin dicarboxylic acid, 3-propyl-2,6-decalin dicarboxylic acid, 3-butyl-2,6-decalin dicarboxylic acid, 3,4-dimethyl-2,6-decalin dicarboxylic acid, 3,4-diethyl-2,6-decalin dicarboxylic acid, 3,4-dipropyl-2,6-decalin dicarboxylic acid, 3,4-dibutyl-2,6-decalin dicarboxylic acid, 3,8-dimethyl-2,6-decalin dicarboxylic acid, 3,8-diethyl-2,6-decalin dicarboxylic acid, 3,8-dipropyl-2,6-decalin dicarboxylic acid, 3,8-dibutyl-2,6-decalin dicarboxylic acid, 3-methyl-4-ethyl-2,6-decalin dicarboxylic acid, 3-methyl-4-propyl-2,6-decalin dicarboxylic acid, 3-methyl-4-butyl-2,6-decalin dicarboxylic acid, and 3-ethyl-4-butyl-2,6-decalin dicarboxylic acid. Among these, 1,4-cyclohexane dicarboxylic acid is particularly preferable.

In addition, examples of derivatives of the polyvalent carboxylic acids used in the same manner as the above-mentioned polyvalent carboxylic acids include ester compounds and acid halides of those dicarboxylic acids. Among these, dicarboxylic acid ester compounds are preferable, and lower alkyl ester compounds having 1 to 6 carbon atoms such as methyl, ethyl, propyl, isopropyl, butyl, amyl and hexyl ester compounds are particularly preferable.

In the present invention, trivalent or higher carboxylic acids can be used for the polyvalent carboxylic acid component within a range that does not impair the effects of the prevent invention in order to raise the glass transition temperature of the polyester resin. Specific examples of trivalent or higher carboxylic acid components include trivalent or higher carboxylic acids such as trimellitic acid, tricarballylic acid, camphoronic acid, trimesic acid, 1,2,5-naphthalene tricarboxylic acid, 2,3,6-naphthalene tricarboxylic acid, 1,8,4-naphthalene tricarboxylic acid, pyromellitic acid, benzophenone tetracarboxylic acid and trimer acids of polymerized fatty acids, as well as ester compounds and acid anhydrides thereof. Their tolerant amount is preferably up to 5 mol %, and more preferably up to 1 mol %, of the total carboxylic acid components. In addition, monocarboxylic acids may also be added in addition to the polycarboxylic acid component within a range that does not impair the effects of the present invention.

(Polyvalent Alcohol Component)

There are no particular limitations on the polyvalent alcohol component used as the starting material of the polyester resin of the present invention, and various known types of polyvalent alcohols can be used, examples of which include aliphatic glycols, alicyclic glycols and aromatic glycols, and one type of these may be used alone, or two or more types may be suitably used in combination.

Examples of the polyvalent alcohol component include aliphatic glycols such as ethylene glycol, diethylene glycol, propylene glycol, 1,4-butanediol, 1,6-hexanediol and neopentyl glycol, and alicyclic glycols such as 1,4-cyclohexane dimethanol. In addition, examples of aromatic polyvalent alcohols include bisphenol A, bisphenol A ethylene oxide and propylene oxide addition products. Moreover, trivalent or more polyvalent alcohols such as glycerin, trimethylol propane and pentaerythritol may also be suitably used.

In addition, known releasing substances can also be used in combination with other components of the present invention to improve releasability between the ink ribbon and receiving layer. Although there are no particular limitations thereon, specific examples of release agents include modified silicone oils such as dimethyl silicone oil, polyether-modified silicone oil, epoxy-modified silicone oil, amino-modified silicone oil, carboxyl-modified silicone oil, carbinol-modified silicone oil and methacrylic acid-modified silicone oil, hydrocarbon-based release agents such as paraffin wax, polyethylene and fluorocarbons, fatty acid-based release agents such as stearic acid, and aliphatic amide-based, ester-based, alcohol-based, metallic soap-based and natural wax-based release agents. Although these release agents are frequently blended within the range of 0.1 to 20 parts by mass based on 100 parts by mass of the thermoplastic resin of the receiving layer, there are no particular limitations thereon.

The thermoplastic resin can also be crosslinked with a crosslinking agent such as polyisocyanate compounds, epoxy compounds and organic metal compounds in order to improve releasability. These crosslinking agents are preferably blended to about 0.1 to 1,000 functions groups of the crosslinking agent to 1 functional group of the thermoplastic resin.

In addition, suitable known dye-dyeable thermoplastic resins may be used in combination in addition to the cellulose acetate butyrate and polyester resin having a number average molecular weight of 10,000 or less. There are no particular limitations thereon, and examples include polyacetal resins such as polyvinyl formal, polyvinyl acetal and polyvinyl butyral resins, BPA type epoxy resin, hydrated BPA type epoxy resin, polyvinyl chloride, polyvinylidene chloride, polyvinyl acetate, polystyrene, styrene-acrylnitrile copolymer, polyethylene, polypropylene, ethylene-vinyl acetate copolymer, polymethyl methacrylate, MMA-styrene copolymer, polyamide, ethyl cellulose, cellulose acetate, propyl cellulose, cellulose nitrate, polycarbonate, phenoxy resin and polyurethane, and one type or two or more types can be used in combination.

In addition, a plasticizer may be used alone or in combination with other plasticizers for the purpose of controlling dye-dyeability. A known plasticizer can be used for the plasticizer, examples of which include phthalic acid ester, aliphatic dibasic acid ester, trimellitic acid ester, phosphoric acid ester, epoxy and polyester-based plasticizers. The incorporated amount of plasticizer is preferably about 1 to 50 parts by mass based on 100 parts by mass of the thermoplastic resin of the receiving layer, and is more preferably incorporated at 1 to 30 parts by mass based on the balance with bleedout.

Moreover, an ultraviolet absorber (UVA) or hindered amine light stabilizer (HALS) can be used alone or in combination to improve light resistance. Although known examples of UVA typically include benzotriazole-based UVA, triazine-based UVA, anilide oxalate-based UVA and benzophenone-based UVA, benzotriazole-based UVA are used particularly preferably since its absorption wavelength region is broader than that of other UVA, has a maximum absorption peak at the high-frequency region, and shows a high absorbance, thereby allowing the obtaining of particularly superior effects when used in combination with HALS. The incorporated amount of UVA is 1 to 70 parts by mass based on 100 parts by mass of the thermoplastic resin of the receiving layer, and an incorporated amount of 1 to 40 parts by mass is used particularly preferably based on the balance between the amount of UVA added and the effects generated thereby. HALS are compounds having a 2,2,6,6-tetramethylpiperidine backbone, and there are no particular limitations on these compounds provided they have this backbone. The incorporated amount of HALS is 1 to 70 parts by mass based on 100 parts by mass of the thermoplastic resin of the receiving layer, and an incorporated amount of 1 to 40 parts by mass is used particularly preferably based on the balance between the amount of HALS added and the effects generated thereby.

The coating amount of the receiving layer in solid content is preferably adjusted to within the range of 1 to 12 g/m² and more preferably 2 to 10 g/m². Incidentally, if the coating amount of the receiving layer in solid content is less than 1 g/m², the receiving layer is unable to completely cover the surface of the substrate, leading to a decrease in image quality or resulting in adhesion problems in which the receiving layer and ink ribbon become adhered due to heating by the thermal head. On the other hand, if the coating amount of the receiving layer in solid content exceeds 12 g/m², not only are the effects saturated making this uneconomical, but the strength of the receiving layer may become inadequate, or the thickness of the receiving layer may increase thereby preventing the insulating effects of the substrate from being adequately demonstrated, which in turn can decrease image density.

(Sheet-Form Substrate)

Paper composed mainly of cellulose pulp or synthetic resin film and so forth is used for the substrate of the receiving sheet in the present invention. Examples of materials suitably used for the substrate include paper such as woodfree paper (acid paper or neutral paper), mechanical paper, coated paper, art paper, glassine paper and resin laminated paper, films or sheets mainly composed of synthetic resins such as polyolefins such as polyethylene and polypropylene, polyesters such as polyethylene terephthalate, polyamide, polyvinyl chloride, polystyrene, polycarbonate, polyvinyl alcohol and polyvinyl chloride, and laminates prepared by laminating and adhering these films or these films together with other films and/or paper, such as porous single-layer oriented films or porous multilayer oriented films mainly composed of polyolefins, polyesters and other thermoplastic resins (e.g., synthetic paper or porous polyester film).

Although there are no particular limitations on the basic material of the surface layer (basic material on the receiving layer side) during lamination, from the viewpoints of homogeneity and gray scale characteristics of printed images, a porous single layer oriented film or porous multilayer oriented film (e.g., synthetic paper or porous polyester film) mainly composed of a thermoplastic resin such as polyolefin or polyester is used preferably.

Moreover, a coating layer containing various types of known conductors, white pigments or fluorescent dyes and so forth can be provided between the sheet-form substrate and the receiving layer to prevent static electricity or improve whiteness.

In the present invention, among the sheet-form substrates described above, paper mainly composed of cellulose pulp is particularly advantageous in terms of costs, and is used preferably since the aesthetic property of the resulting receiving sheet approaches that of printing paper. In general, various coating layers are formed on the paper substrate and when the receiving layer is provided thereon, cracks tend to form easily. Therefore, use of the receiving layer of the present invention allows adequate effects to be obtained. In particular, superior effects are obtained in a thermal transfer receiving sheet at least having an intermediate layer containing hollow particles between the sheet-form substrate and the receiving layer.

In addition, a sheet-form substrate having a thickness of 20 to 30 μm is a preferable one used in the present invention.

In addition, the sheet-form substrate of the present invention may be composed by sequentially laminating a first base layer in which the receiving layer is formed, a pressure-sensitive adhesive layer, a release agent layer and a second base layer and so forth, and a substrate having a so-called sticker, label or seal type of structure can naturally also be used.

(Intermediate Layer)

In the case of using paper for the structure, it is preferable to at least provide an intermediate layer containing hollow particles on one side of the paper to improve printing density, image quality and other aspects of printing quality.

The hollow particles used in the intermediate layer of the present invention are composed of a sheet formed from a polymer material, and one or more hollow (pore) portions surrounded thereby. There are no particular limitations on the production process thereof, and those produced in the manner described below, for example, can be selected for use thereof:

(a) foamed hollow particles prepared by heating and foaming a thermoplastic polymer material containing a thermally expanding substance (hereinafter, simply referred to as foamed hollow particles); and,

(b) microcapsular hollow particles prepared by using a polymer-forming material as the shell-forming material, with a volatile liquid as the pore-forming material, and volatilizing the pore-forming material from the microcapsules produced by microcapsule-forming polymerization (hereinafter, simply referred to as microcapsular hollow particles).

Foamed hollow particles are used preferably in the intermediate layer of the present invention. Foamed hollow particles are obtained by, for example, enclosing a volatile, low boiling point hydrocarbon such as n-butane, i-butane, pentane or neopentane in a thermoplastic polymer material for use as the thermally expanding substance, using a homopolymer of vinylidene chloride, vinyl chloride, acrylonitrile, methacrylonitrile, styrene (meth)acrylic acid or (meth)acrylic acid ester or copolymer thereof as a thermoplastic polymer material for the shell (wall) material, and treating the resulting particles by preheating and so forth to thermally expand to a predetermined particle diameter.

In addition, since foamed hollow particles as described above typically have a low specific gravity, an inorganic powder such as calcium carbonate, talc or titanium dioxide can be adhered to the surface of the foamed hollow particles by thermal adhesion for the purpose of improving dispersivity or improving handling ease, and these foamed compound hollow particles having a surface coated with an inorganic powder can also be used in the present invention.

In addition, microcapsular hollow particles preferably used in the intermediate layer of the present invention are obtained by microcapsule-forming polymerization, microcapsules containing a polymer-forming material (shell-forming material) are used for the shell (wall) and a volatile liquid (pore-forming material) for the core are dried, followed by volatilization of the pore-forming material to form hollow cores. Examples of preferably used polymer-forming materials include hard resins such as styrene(meth)acrylic acid ester-based copolymers and melamine resins, while water, for example, is used for the volatile liquid.

The average particle diameter of the hollow particles used in the present invention is preferably 0.3 to 25 μm, more preferably 0.5 to 15 μm, and most preferably 1 to 9 μm. If the average particle diameter of the hollow particles is less than 0.3 μm, the volumetric hollow rate of the hollow particles is generally low, thereby preventing the effect of improving the sensitivity of the receiving sheet from being adequately demonstrated. In addition, if the average particle diameter exceeds 25 μm, the smoothness of the resulting intermediate layer surface decreases, thereby resulting in poor homogeneity of thermal transfer images and inadequate image quality.

Furthermore, the average particle diameter of the hollow particles can be measured using an ordinary particle diameter measuring apparatus, and is measured using, for example, a laser diffraction-type particle size distribution measuring instrument (trade name: SALD2000, Shimadzu Corp.).

The volumetric hollow rate of the hollow particles used in the present invention is preferably 30 to 97%, and more preferably 45 to 95%. In the case the volumetric hollow rate of the hollow particles is less than 30%, the effects of improving the sensitivity of the receiving sheet overall are not adequately demonstrated. In addition, if the volumetric hollow rate exceeds 97%, the coated film strength of the intermediate layer decreases, the intermediate layer is susceptible to damage, and appearance becomes poor.

Furthermore, the volumetric hollow rate of the hollow particles refers to the ratio of the volume of the hollow portion to the particle volume, and more specifically, can be calculated from the specific gravity of hollow particle dispersion composed of the hollow particles and a poor solvent, the mass fraction of the hollow particles in the aforementioned dispersion and the true specific gravity of a polymer resin that forms the shell (wall) of the hollow particles, as well as the specific gravity of the poor solvent. In addition, the average particle diameter and volumetric hollow rate of the hollow particles can also be determined from observations of cross-sectional photomicrographs of the cross-sections thereof with a scanning electron microscope (SEM) or transmission electron microscope (TEM).

In the intermediate layer of the present invention, the mass ratio of the hollow particles to the total solid component of the intermediate layer is preferably 20 to 80% by mass, and more preferably 25 to 70% by mass. If the mass ratio of the hollow particles is less than 20% by mass, the effect of improving the sensitivity of the receiving sheet is inadequate, while if the mass ratio of the hollow particles exceeds 80% by mass, the coatability of the intermediate layer coating solution becomes poor, and prevents the obtaining of a satisfactory coated surface while also reducing the coated film strength of the intermediate layer.

The intermediate layer of the present invention contains hollow particles and an adhesive resin. The intermediate layer coating solution of the present invention is preferably an aqueous coating solution in consideration of the solvent resistance of the hollow particles. There are no particular limitations on the adhesive resin used, and preferable examples of adhesive resins from the viewpoint of film deposition, heat resistance and plasticity include vinyl alcohol resins, cellulose resins and derivatives thereof, casein and starch derivatives and other hydrophilic polymer resins. In addition, emulsions of various types of resins such as (meth)acrylic acid ester resin, styrene-butadiene copolymer resin, urethane resin, polyester resin and ethylene-vinyl acetate copolymer resin are used as aqueous resins of low-viscosity polymer solid components. Furthermore, from the viewpoints of coated film strength, adhesion and coatability of the intermediate layer, the adhesive resin used in the intermediate layer can be a combination of the aforementioned hydrophilic polymer resins and an emulsion of various types of resins.

The intermediate layer may also use one or more types of additives suitably selected from the group comprising, for example, antistatic agents, inorganic pigments, organic pigments, resin crosslinking agents, antifoaming agents, dispersants, colored dyes, release agents and lubricants.

The thickness of the intermediate layer in order to demonstrated desired performance such as cushioning and improved luster is preferably 20 to 90 μm, and more preferably 25 to 85 μm. If the thickness of the intermediate layer is less than 20 μm, cushioning becomes inadequate, and the effects of improving sensitivity and image quality are inadequate. In addition, if the thickness exceeds 90 μm, insulating and cushioning effects become saturated, and performance beyond that level cannot be obtained, thereby making this economically disadvantageous.

(Barrier Layer)

In the present invention, a barrier layer is preferably provided between the intermediate layer and the receiving layer. Since an organic solvent such as toluene or methyl ethyl ketone is typically used for the solvent of the receiving layer coating solution, the barrier layer is effective as a barrier for preventing deformation and destruction of the hollow particles in the intermediate layer due to swelling or dissolution of the hollow particles caused by penetration of organic solvent.

A resin having superior film-forming ability that prevents penetration of organic solvent and has elasticity and flexibility is used for the barrier layer. Specific examples of resins used include aqueous resins such as starch, modified starch, hydroxyethyl cellulose, methyl cellulose, carboxymethyl cellulose, gelatin, casein, gum Arabic, completely saponified polyvinyl alcohol, partially saponified polyvinyl alcohol, carboxy-modified polyvinyl alcohol, acetoacetyl group-modified polyvinyl alcohol, isobutylene-maleic anhydride copolymer salt, styrene-maleic anhydride copolymer salt, styrene-acrylic acid copolymer salt, ethylene-acrylic acid copolymer salt, urea resin, urethane resin, melamine resin, amide resin and other water-soluble resins. In addition, water-dispersible resins can also be used, examples of which include styrene-butadiene copolymer latex, acrylic acid ester resin-based latex, methacrylic acid ester-based copolymer resin latex, ethylene-vinyl acetate copolymer latex, polyester polyurethane ionomer and polyether-polyurethane ionomer. Among the aforementioned resins, water-soluble resins are used preferably. In addition, the aforementioned resins may be used alone or two or more types may be used in combination.

Moreover, various types of pigment may be contained in the barrier layer, and swellable inorganic layered compound is used preferably, the use thereof not only prevents penetration of coating solvent, but also allows the obtaining of superior effects with respect to preventing bleeding of thermal transfer dye-dyeable images. Examples of preferably used swellable inorganic layered compounds include synthetic micas such as fluorophlogopite, potassium tetrasilicic mica, sodium tetrasilicic mica, sodium taeniolite and lithium taeniolite, or synthetic smectites such as sodium hectorite, lithium hectorite and saponite. Compounds having a desired particle diameter, aspect ratio and crystallinity are obtained by fusion synthesis.

The aspect ratio of the swellable inorganic layered compound is preferably within the range of 5 to 5,000, more preferably within the range of 100 to 5,000 and particularly preferably within the range of 500 to 5,000. If the aspect ratio is less than 5, image bleeding may occur, while if the aspect ratio exceeds 5,000, image homogeneity becomes inferior. The aspect ratio (Z) is expressed by the relationship of Z=L/a, wherein L represents the particle average major axis in water of the swellable inorganic layered compound (determined by laser diffraction method using the LA-910 particle size distribution analyzer manufactured by Horiba, Ltd., which measures the median diameter of a volumetric distribution of 50%), and a represents the thickness of the swelling, inorganic layered compound.

The thickness a of the swellable inorganic layered compound is the value determined by observing photomicrograph a cross-section of the barrier layer with a scanning electron microscope (SEM) or transmission electron microscope (TEM). The particle average major axis of the swellable inorganic layered compound is 0.1 to 100 μm, preferably 0.3 to 50 μm, and more preferably 0.5 to 20 μm. If the particle average major axis is less than 0.1 μm, in addition to decreasing the aspect ratio, it becomes difficult to lay the barrier layer level on the intermediate layer, which may prevent image bleeding from being completely prevented. If the particle average major axis exceeds 100 μm, the swellable inorganic layered compound ends up protruding from the barrier layer, causing surface irregularities in the surface of the barrier layer and deteriorating the smoothness of the receiving layer surface, thereby resulting in decreased image quality.

In addition, a white inorganic pigment or fluorescent dye such as calcium carbonate, titanium dioxide, zinc oxide, aluminum hydroxide, barium sulfate, silicon dioxide, aluminum oxide, talc, kaolin, diatomaceous earth or satin white may be contained in the form of an inorganic pigment in the barrier layer to impart opacity and whiteness and improve the texture of the receiving sheet.

The coating amount of the barrier layer in solid content is preferably within the range of 0.5 to 8 g/m², more preferably 1 to 7 g/cm² and particularly preferably 1 to 6 g/m². Incidentally, if the coating amount of the barrier layer is solid content is less than 0.5 g/m², the barrier layer is unable to completely cover the surface of the intermediate layer, and the effect of preventing penetration of organic solvent becomes inadequate. On the other hand, if the coating amount of the barrier layer is solid content exceeds 8 g/m², coating effects become saturated, which in addition to being uneconomical, prevents insulating and cushioning effects from being adequately demonstrated due to excessive thickness of the barrier layer, thereby leading to a possible decrease in image density.

(Back Coating Layer)

In the receiving sheet of the present invention, a back coating layer may be formed on the opposite side from the receiving layer (back side) for the purpose of improving transportability, preventing static electricity, preventing damage to the receiving layer caused by mutual rubbing of receiving sheets, and preventing dye transfer from a receiving layer to the back of a printed receiving sheet in contact with and adjacent thereto when printed receiving sheets are stacked. Various types of conductors can be added to the back coating layer to prevent charge transfer with the resin serving as the adhesive component. A cationic polymer is preferably used for this conductor. Polyethylene imines, acrylic polymers containing a cationic monomer, cation-modified acrylamide polymers and cationic starch can typically be used for the cationic polymer. The coating amount of the back coating layer in solid content is preferably within the range of 0.3 to 10.0 g/m².

The receiving layer and other coating layers of the receiving sheet of the present invention can be formed by coating using a bar coater, gravure coater, blade coater, air knife coater, gate roll coater, curtain coater, dye coater or slide bead coater followed by drying.

In the present invention, calendaring may be carried out on the receiving sheet to reduce surface irregularities in the surface of the receiving layer and smoothen the surface. For example, in the case of using paper for the substrate, calendaring may be carried out at any stage following coating of the intermediate layer, barrier layer or receiving layer. Although there are no particular limitations on the calendaring apparatus used for calendaring, nip pressure, number of nips or surface temperature of the metal roller, the pressure during calendaring is preferably 0.5 to 50 MPa, and more preferably 1 to 30 MPa. The temperature is preferably 20 to 150° C., and more preferably 30 to 130° C. A calendaring apparatus ordinarily used in the paper manufacturing industry can be suitably used for the calendaring apparatus, examples of which include a super calendar, soft calendar, gross calendar or clearance calendar.

### EXAMPLES

Although the following provides a more detailed explanation of the present invention by indicating examples thereof, the present invention is naturally not limited thereby. Unless specifically indicated otherwise, the terms “parts” and “%” in the examples refer to “parts by mass” and “% by mass” in all cases, and indicate the mass of the solid component with the exception of solvents.

[Production of Polyester Resin]

Various polyester resins were synthesized according to a known method using the polyvalent carboxylic acid components and polyvalent alcohol components shown in Table 1 below.

TABLE 1

| | | | | | | | Polyvalent | | |
|---|---|---|---|---|---|---|---|---|---|
| | | | | | | | alcohol (mol %) | | |
| | Polyvalent Carboxylic Acid (mol %) | | | | | | Bis- | | |
| | | | | | | 1,4-cyclo- | phenol A | | Number |
| | | | | | | hexane | EO | | average |
| Polyester | Terephthalic | Isophthalic | Maleic | Succinic | Malonic | dicarboxylic | addition | Ethylene | molecular |
| resin | acid | acid | anhydride | anhydride | acid | acid | product | glycol | weight |
| A | 50 | 50 | | | | | 60 | 40 | 8,000 |
| B | | | 55 | | | 45 | 60 | 40 | 8,000 |
| C | | | | 55 | | 45 | 60 | 40 | 8,000 |
| D | | | | 55 | | 45 | 60 | 40 | 1,000 |
| E | | | | | 55 | 45 | 60 | 40 | 8,000 |
| F | | | 70 | | | 30 | 60 | 40 | 8,000 |
| G | | | 30 | | | 70 | 60 | 40 | 8,000 |
| H | | | 55 | | | 45 | 60 | 40 | 11,000 |
| I | 50 | 50 | | | | | 60 | 40 | 17,000 |

### Example 1

[Production of Receiving Sheet]

A porous multilayer structure film consisting mainly of biaxially oriented polypropylene (trade name: Yupo FPG50, Yupo Corp.) was laminated onto both sides of woodfree paper having a thickness of 100 μm by dry lamination to obtain a sheet-form substrate. The receiving layer coating solution A shown below was coated onto one side of this sheet-form substrate to a coating amount in solid content of 5 g/m² followed by drying (120° C., 1 minute) and heat treating for 4 days at 50° C. to produce a receiving sheet.

Receiving Layer Coating Solution A

| | | |
|---|---|---|
| Cellulose acetate butyrate (trade name: | 50 | parts |
| CAB551-0.01, Eastman, number average | | |
| molecular weight: 16,000) | | |
| Polyester resin A | 50 | parts |
| Silicone oil (trade name: KF393, | 4 | parts |
| Shin-Etsu Chemical) | | |
| Isocyanate compound (trade name: NY-710A, | 5 | parts |
| Mitsubishi Chemical) | | |
| Toluene | 100 | parts |
| Methyl ethyl ketone | 100 | parts |

### Example 2

A receiving sheet was produced in the same manner as Example 1 with the exception of using the following receiving layer coating solution B instead of the receiving layer coating solution A.

Receiving Layer Coating Solution B

| | | |
|---|---|---|
| Cellulose acetate butyrate (trade name: | 50 | parts |
| CAB500-5, Eastman, number average | | |
| molecular weight: 57,000) | | |
| Polyester resin A | 50 | parts |
| Silicone oil (trade name: KF393, | 4 | parts |
| Shin-Etsu Chemical) | | |
| Isocyanate compound (trade name: NY-710A, | 5 | parts |
| Mitsubishi Chemical) | | |
| Toluene | 100 | parts |
| Methyl ethyl ketone | 100 | parts |

### Example 3

A receiving sheet was produced in the same manner as Example 2 with the exception of using polyester resin B instead of polyester resin A in the receiving layer coating solution B of Example 2.

### Example 4

A receiving sheet was produced in the same manner as Example 2 with the exception of using polyester resin C instead of polyester resin A in the receiving layer coating solution B of Example 2.

### Example 5

A receiving sheet was produced in the same manner as Example 2 with the exception of using polyester resin D instead of polyester resin A in the receiving layer coating solution B of Example 2.

### Example 6

A receiving sheet was produced in the same manner as Example 2 with the exception of using polyester resin E instead of polyester resin A in the receiving layer coating solution B of Example 2.

### Example 7

A receiving sheet was produced in the same manner as Example 2 with the exception of using polyester resin F instead of polyester resin A in the receiving layer coating solution B of Example 2.

### Example 8

A receiving sheet was produced in the same manner as Example 2 with the exception of using polyester resin G instead of polyester resin A in the receiving layer coating solution B of Example 2.

### Example 9

[Formation of Intermediate Layer]

An intermediate layer was formed by using art paper having a thickness of 150 μm (trade name: OK Kinfuji N, 174.4 g/m², Oji Paper) for the sheet-form substrate, and coating intermediate layer coating solution 1 having the composition indicated below onto one side thereof to a film thickness after drying of 51 μm followed by drying.

Intermediate Layer Coating Solution 1

| | | |
|---|---|---|
| Foamed hollow particles composed of a | 50 | parts |
| copolymer mainly composed of acrylonitrile | | |
| and methacrylonitrile (average particle | | |
| diameter: 3.2 μm, volumetric hollow | | |
| rate: 76%) | | |
| Polyvinyl alcohol (trade name: PVA205, | 10 | parts |
| Kuraray) | | |
| Styrene-butadiene latex (trade name: | 40 | parts |
| PT1004, Zeon Corp.) | | |
| Water | 250 | parts |

[Formation of Barrier Layer and Receiving Layer]

A barrier layer coating solution 1 having the composition indicated below was further coated onto the aforementioned intermediate layer to a coating amount in solid content of 2 g/m² followed by drying to form a barrier layer, after which the aforementioned receiving layer coating solution B (prepared in Example 2) was coated onto the barrier layer to a coating amount in solid content of 5 g/m² followed by drying to form a receiving layer.

Barrier Layer Coating Solution 1

| | |
|---|---|
| Swelling, inorganic layered compound (sodium | 30 parts |
| tetrasilicic mica, particle average major | |
| axis: 6.3 μm, aspect ratio: 2700) | |
| Polyvinyl alcohol (trade name: PVA105, | 50 parts |
| Kuraray) | |
| Styrene-butadiene latex (trade name: | 20 parts |
| L-1537, Asahi Kasei) | |
| Water | 1100 parts |

[Formation of Receiving Sheet]

Next, a back coating layer coating solution 1 having the composition indicated below was coated onto the opposite side of the sheet-form substrate from the side provided with the receiving layer at a coating amount in solid content of 3 g/m² followed by drying to form a back coating layer, after which heat treatment was carried out for 4 days at 50° C. Moreover, a receiving sheet was produced after carrying out calendaring (roll surface temperature: 78° C., nip pressure: 2.5 MPa) to smoothen the surface of the receiving sheet.

Back Coating Layer Coating Solution 1

| | |
|---|---|
| Polyvinyl acetal resin (trade name: | 40 parts |
| S-LEC KX-1, Sekisui Chemical) | |
| Polyacrylic acid ester resin (trade name: | 20 parts |
| Jurymer AT613, Nihon Junyaku) | |
| Nylon resin particles (trade name: MW330, | 10 parts |
| Shinto Paint) | |
| Zinc stearate (trade name: Z-7-30, | 10 parts |
| Chukyo Yushi) | |
| Cationic conductive resin (trade name: | 20 parts |
| Chemistat 9800, Sanyo Chemical Industries) | |
| Mixture of water/isopropyl alcohol = 2/3 | 400 parts |
| (mass ratio) | |

### Example 10

A receiving sheet was produced in the same manner as Example 9 with the exception of using polyester resin B instead of polyester resin A in the receiving layer coating solution B of Example 9.

### Example 11

A receiving sheet was produced in the same manner as Example 9 with the exception of using polyester resin C instead of polyester resin A in the receiving layer coating solution B of Example 9.

### Comparative Example 1

A receiving sheet was produced in the same manner as Example 1 with the exception of using the receiving layer coating solution C indicated below instead of the receiving layer coating solution A.

Receiving Layer Coating Solution C

| | | |
|---|---|---|
| Cellulose acetate butyrate (trade name: | 100 | parts |
| CAB500-5, Eastman, number average | | |
| molecular weight: 57,000) | | |
| Silicone oil (trade name: KF393, | 4 | parts |
| Shin-Etsu Chemical) | | |
| Isocyanate compound (trade name: NY-710A, | 5 | parts |
| Mitsubishi Chemical) | | |
| Toluene | 100 | parts |
| Methyl ethyl ketone | 100 | parts |

### Comparative Example 2

A receiving sheet was produced in the same manner as Example 1 with the exception of using the receiving layer coating solution D indicated below instead of the receiving layer coating solution A.

Receiving Layer Coating Solution D

| | | |
|---|---|---|
| Polyester resin A (number average molecular | 100 | parts |
| weight: 8,000) | | |
| Silicone oil (trade name: KF393, | 4 | parts |
| Shin-Etsu Chemical) | | |
| Isocyanate compound (trade name: NY-710A, | 5 | parts |
| Mitsubishi Chemical) | | |
| Toluene | 100 | parts |
| Methyl ethyl ketone | 100 | parts |

### Comparative Example 3

A receiving sheet was produced in the same manner as Example 2 with the exception of using polyester resin H instead of polyester resin A in the receiving layer coating solution B of Example 2.

### Comparative Example 4

A receiving sheet was produced in the same manner as Example 2 with the exception of using polyester resin I instead of polyester resin A in the receiving layer coating solution B of Example 2.

Evaluation

The receiving sheets obtained in the each of the aforementioned examples and comparative examples were tested as described below. The results thereof are shown in Table 2.

[Evaluation of Receiving Sheet Appearance]

A sensory evaluation was made of the appearance of the receiving sheets. The receiving sheets were evaluated as “Good” if the receiving layer coated surface had luster, and “Failure” if it was cloudy. The product value of the receiving sheet decreases considerably in the case of being “Failure”.

[Protective Layer Transfer Test]

The protective layer portion of a sublimation thermal transfer ribbon (trade name: UP-540, Sony) was transferred to the receiving layer of the resulting receiving sheets using a thermal transfer tester (trade name: TH-PM12, Okura Electric) while varying the printing energy followed by determining the minimum energy at which the protective layer is able to be transferred. In this protective layer transfer test, the receiving sheet was judged to have a level of transferability not presenting problems in terms of practical use if the minimum protective layer transfer energy was 1 mj/dot or less.

[Ribbon Release Test]

Ten sheets of solid black images were consecutively printed in a 50° C. environment using a commercially available thermal transfer video printer (trade name: UP-50, Sony) in which a sublimation thermal transfer ribbon (trade name: UP-540, Sony) was adhered to the resulting receiving sheets. At that time, the adhesion status between the receiving sheet and ribbon and the ease of discharge of the receiving sheet from the printer were evaluated as indicators of printing compatibility based on the criteria indicated below.
Good: Ten consecutive sheets discharged normally with no adhesion whatsoever between the receiving sheet and ribbon, and no problems whatsoever in terms of practical use.
Fair: All ten sheets discharged with slight generation of noise due to mild adhesion between the receiving sheet and ribbon, although able to be used practically.
Failure: Some sheets failed to be discharged normally due to occurrence of adhesion between receiving sheet and ribbon, and not suited for practical use.

[Printing Density Test]

Solid black images were printed in a 20° C. environment onto the resulting receiving sheets using a commercially available thermal transfer video printer (trade name: UP-50, Sony) in which a sublimation thermal transfer ribbon (trade name: UP-540, Sony) was adhered to the resulting receiving sheets, followed by measuring printing density using a reflection densitometer (trade name: Macbeth RD-914, Gretag). Printing density was measured at five locations, and was judged to be of a level not present problems in terms of practical use if the average value of the density at those five locations was 2.1 or more.

[Light Resistance Test]

The aforementioned printed images were treated to an integrated luminosity of 10,000 kJ/m² with an Xe fade meter. Color difference was measured before and after treatment using a color difference meter (Gretag). Light resistance was judged to be of a level not presenting problems in terms of practical use if the color difference was within 13.

[Crack Test]

The resulting receiving sheets were wrapped around an iron pipe having a diameter of 11 mm in a 0° C. environment followed by macroscopic observation of the formation of cracks in the receiving layer.
Good: Level suitable for practical use without any cracks formed in the receiving layer.
Fair: Slight cracks formed in the receiving layer, but able to be used practically.

Failure: Numerous cracks formed in the receiving layer and unsuitable for practical use.

TABLE 2

| | | Protective | | | | |
|---|---|---|---|---|---|---|
| | Receiving | layer | | | | Receiving |
| | sheet | transferability | Ribbon | Image | Image light | layer |
| | appearance | (mj/dot) | releasability | density | resistance | cracking |
| Ex. 1 | Good | 0.7 | Good | 2.32 | 9 | Fair |
| Ex. 2 | Good | 0.7 | Good | 2.31 | 9 | Good |
| Ex. 3 | Good | 0.7 | Good | 2.30 | 5 | Good |
| Ex. 4 | Good | 0.7 | Good | 2.25 | 5 | Good |
| Ex. 5 | Good | 0.7 | Good | 2.27 | 5 | Good |
| Ex. 6 | Good | 0.7 | Good | 2.26 | 5 | Good |
| Ex. 7 | Good | 0.3 | Fair | 2.20 | 6 | Good |
| Ex. 8 | Good | 0.8 | Good | 2.22 | 12 | Good |
| Ex. 9 | Good | 0.7 | Good | 2.31 | 9 | Good |
| Ex. | Good | 0.7 | Good | 2.30 | 5 | Good |
| 10 | | | | | | |
| Ex. | Good | 0.7 | Good | 2.25 | 5 | Good |
| 11 | | | | | | |
| Comp. | Good | 0.6 | Good | 1.86 | 3 | Good |
| Ex. 1 | | | | | | |
| Comp. | Good | 1.2 | Good | 2.47 | 20 | Failure |
| Ex. 2 | | | | | | |
| Comp. | Failure | 0.9 | Good | 2.21 | 14 | Good |
| Ex. 3 | | | | | | |
| Comp. | Failure | 0.7 | Good | 2.20 | 16 | Good |
| Ex. 4 | | | | | | |

### INDUSTRIAL APPLICABILITY

The receiving sheet of the present invention is able to greatly contribute to industry as a result of having superior protective layer transferability and ribbon releasability, high printing density, superior image light resistance, absence of crack formation in the receiving layer, and being useful in various types of thermal transfer full-color printers including sublimation thermal transfer printers.

1: A thermal transfer receiving sheet comprising a sheet-form substrate and a receiving layer having as a main component thereof a dye-dyeable resin formed on at least one side of said sheet-form substrate; wherein the receiving layer contains cellulose acetate butyrate and polyester resin having a number average molecular mass of up to 10,000.

2: The thermal transfer receiving sheet according to claim 1, wherein the blending mass ratio of the cellulose acetate butyrate and the polyester resin is 5/95 to 95/5.

3: The thermal transfer receiving sheet according to claim 2, wherein the number average molecular weight of the cellulose acetate butyrate is at least 20,000.

4: The thermal transfer receiving sheet according to claim 3, wherein the polyester resin is a resin obtained by polycondensation of a polyvalent carboxylic acid component and a polyvalent alcohol component, the aliphatic dicarboxylic acid content of the polyvalent carboxylic acid content is greater than 50 mol %, and the alicyclic dicarboxylic acid content of the polyvalent carboxylic acid component is less than 50 mol %.

5: The thermal transfer receiving sheet according to claim 1, wherein the number average molecular weight of the cellulose acetate butyrate is at least 20,000.

6: The thermal transfer receiving sheet according to claim 5, wherein the polyester resin is a resin obtained by polycondensation of a polyvalent carboxylic acid component and a polyvalent alcohol component, the aliphatic dicarboxylic acid content of the polyvalent carboxylic acid content is greater than 50 mol %, and the alicyclic dicarboxylic acid content of the polyvalent carboxylic acid component is less than 50 mol %.

7: The thermal transfer receiving sheet according to claim 1, wherein the polyester resin is a resin obtained by polycondensation of a polyvalent carboxylic acid component and a polyvalent alcohol component, the aliphatic dicarboxylic acid content of the polyvalent carboxylic acid content is greater than 50 mol %, and the alicyclic dicarboxylic acid content of the polyvalent carboxylic acid component is less than 50 mol %.

8: The thermal transfer receiving sheet according to claim 2, wherein the polyester resin is a resin obtained by polycondensation of a polyvalent carboxylic acid component and a polyvalent alcohol component, the aliphatic dicarboxylic acid content of the polyvalent carboxylic acid content is greater than 50 mol %, and the alicyclic dicarboxylic acid content of the polyvalent carboxylic acid component is less than 50 mol %.
